(19) United States
(12) Patent Application Publication
(10) Pub. No.: US 2013/0278623 A1
(43) Pub. Date: Oct. 24, 2013

(54) PROVIDING A CORRELATION RING FOR INDICATING CORRELATION BETWEEN ATTRIBUTES

(71) Applicants: MING C. HAO, Palo Alto, CA (US); Manish Marwah, Palo Alto, CA (US); Umeshwar Dayal, Saratoga, CA (US); Cullen E. Bash, Los Gatos, CA (US); Sebastian Mittelstädt, Konstanz (DE); Halldór Janetzko, Konstanz (DE); Daniel Keim, Stelsslingen (DE); Yuan Chen, Sunnyvale, CA (US); Chandrakant Patel, Fremont, CA (US); Meichun Hsu, Los Altos Hills, CA (US)

(72) Inventors: MING C. HAO, Palo Alto, CA (US); Manish Marwah, Palo Alto, CA (US); Umeshwar Dayal, Saratoga, CA (US); Cullen E. Bash, Los Gatos, CA (US); Sebastian Mittelstädt, Konstanz (DE); Halldór Janetzko, Konstanz (DE); Daniel Keim, Stelsslingen (DE); Yuan Chen, Sunnyvale, CA (US); Chandrakant Patel, Fremont, CA (US); Meichun Hsu, Los Altos Hills, CA (US)

(21) Appl. No.: 13/450,598

(22) Filed: Apr. 19, 2012

(51) Int. Cl. G09G 5/00

(52) U.S. Cl. 345/619

(57) ABSTRACT

Pixels representing attributes of data records are into discrete rings of a graphical visualization, where the discrete rings correspond to respective ones of the attributes, and where the pixels are arranged in each of the discrete rings according to time intervals of the data records. A correlation ring is provided in the graphical visualization in addition to the discrete rings, where the correlation ring has visual indicators for indicating degrees of correlation between at least two of the attributes.

### BACKGROUND

An enterprise can collect a relatively large amount of data records over time. Such data records can be visualized in graphical visualizations. However, visualizing relatively large amounts of data records can be associated with various challenges.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures:

FIG. 1 illustrates an example graphical visualization that includes discrete rings of pixels, including a correlation ring according to some implementations;

FIGS. 2 and 3 are flow diagrams of processes of providing a graphical visualization, according to various implementations;

FIG. 4 illustrates parameters associated with discrete rings of a graphical visualization according to some implementations; and

FIG. 5 is a block diagram of an example system incorporating some implementations.

### DETAILED DESCRIPTION

An enterprise (e.g. business concern, educational organization, government agency, individual, etc.) can collect a relatively large amount of data records. For example, an enterprise can receive measurements from various monitoring devices in a system, such as a network of devices, a data center, a system of storage devices, and so forth. The collected measurements can include performance measurements, such as utilization of computer servers, utilization of storage devices, data rates through communication devices, and so forth. In other examples, data records can include other types of data, such as financial data (e.g. revenue, profit, etc.) of the enterprise, user feedback (expressing user sentiments regarding a product or service offering, for example) collected by the enterprise, data relating to a physical infrastructure (e.g. power utilization, water utilization, etc.), and so forth.

The collected data records can be in the form of time series or other types of data collections. A data record can generally refer to a representation of data that can have one or multiple attributes. One example of an attribute can be a time attribute, which can indicate a time associated with the data record (e.g. time that the data was acquired or received). Another attribute can represent a value that is being measured, such as processor utilization, storage utilization, data rate, profit, revenue, user sentiment, and so forth.

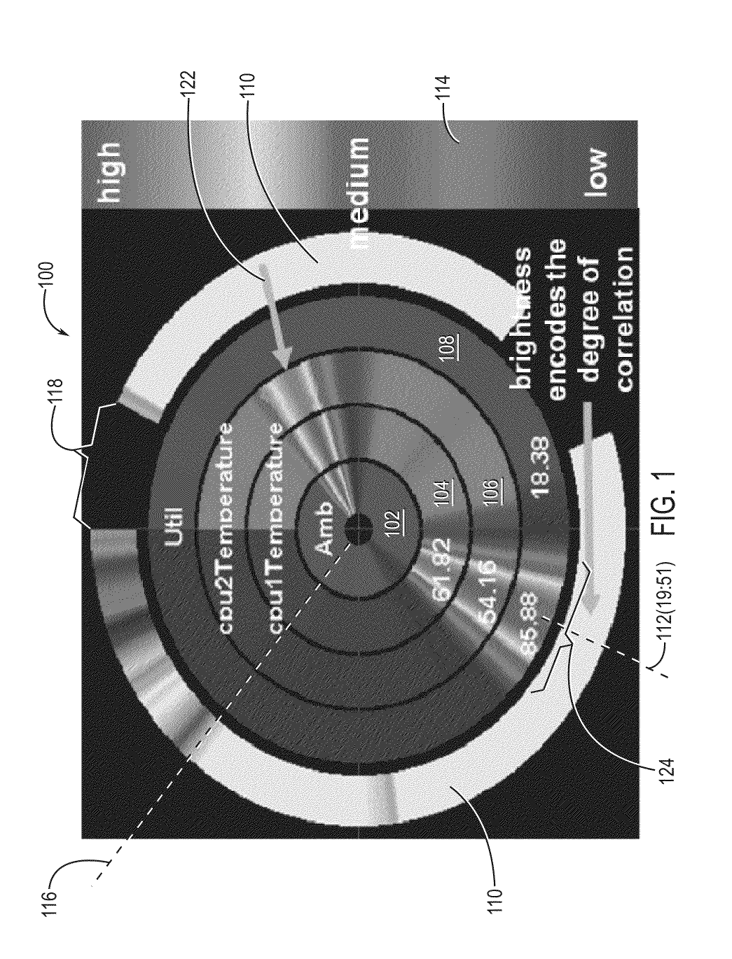

In some cases, it may be desirable to visualize correlations among two or more attributes associated with the data records at the various time intervals. Recognizing such correlations in a relatively large volume of data records can be challenging. In accordance with some implementations, a ring-based graphical visualization, such as 100 in FIG. 1, is provided that includes discrete annular rings 102, 104, 106, and 108 of pixels. The multiple discrete annular rings 102, 104, 106, and 108 correspond to respective different attributes. The ring-based graphical visualization can also be referred to as a multi-variable or multi-attribute ring-based graphical visualization.

The pixels within each discrete ring represent corresponding data records in respective time intervals (e.g. a time interval can be a measurement interval during which a measurement can be taken to provide a value of a data record). Note that a discrete annular ring can be generally circular in shape. Alternatively, a discrete annular ring can have a different shape, such as a rectangular shape, a polygon shape, and so forth.

In addition to the discrete annular rings that include pixels representing various attributes of data records, a correlation ring 110 can be provided to indicate correlation among two or more attributes represented in the discrete rings 102, 104, 106, and 108.

In a specific example according to FIG. 1, the different attributes represented by corresponding ones of the discrete rings 102, 104, 106, and 108 are: ambient temperature (Amb), a temperature of a first CPU (cpu1Temperature), a temperature of a second CPU (cpu2Temperature), and system utilization (Util). The ambient temperature (Amb) can represent a temperature in an enclosure of a system, such as a rack in a data center, a computer system, storage system, communications system, and so forth. The system can include multiple central processing units (CPUs), and temperature measurements can be collected for the respective multiple CPUs. In the example of FIG. 1, two temperature measurements are collected for two respective CPUs: cpu1Temperature, cpu2Temperature. Additionally, utilization of the system can be measured, and represented as Util. Utilization can refer to a collective utilization of the CPUs of the system, for example.

Within each discrete ring 102, 104, 106, or 108, the pixels are temporally arranged according to the time intervals of the data records being represented by the discrete ring. For example, in ring 102, the pixels are arranged according to time intervals corresponding to the data records that contain the Amb attribute; in ring 104, the pixels are arranged according to time intervals corresponding to the data records that contain the cpu1Temperature attribute; and so forth. Stated differently, each of the discrete rings 102, 104, 106, and 108 represents a time series of values of a corresponding different attribute.

Each pixel can represent a data record for a particular time interval (e.g., minute). Assuming that each discrete ring represents attribute values collected over a day, then there can be 1,440 (24×60) pixels in each discrete ring, to represent the 1,440 minutes within each day. In a different example, each pixel can represent a data record for an hour—in such example, a discrete ring that represents attribute values collected over a day would include 24 pixels, to represent the 24 hours within each day.

Additionally, the pixels across different annular rings are temporally aligned such that along a given radial axis in the graphical visualization 100, the pixels in the different annular rings 102, 104, 106, and 108 represent the same time interval. For example, temporally aligning the pixels along a radial axis across different annular rings can refer to the fact that the pixels in the different discrete rings along the radial axis represent data records at the same minute. For example, a radial axis 112 depicted in FIG. 1 can correspond to the 51^{st} minute of hour 19 (19:51). The pixels in the discrete annular rings 102, 104, 106, and 108 that are along the radial axis 110 represent data records for hour 19, minute 51 (19:51) for their respective four attributes.

The pixels in the discrete rings 102, 104, 106, and 108 are assigned corresponding visual indicators, which can be colors as shown in FIG. 1. A color scale 114 is depicted in FIG. 1 and maps different colors to different values of the attribute that is being depicted. Pixels in a discrete ring representing a corresponding time series of attribute values at corresponding time intervals are assigned different colors (or other visual indicators) to allow changes of the corresponding attribute over time to be observed.

For example, in the ring 102, different colors are assigned to pixels according to different values of the Amb attribute. A red color indicates a higher ambient temperature, while a green color represents a lower ambient temperature.

In addition to the discrete annular rings 102, 104, 106, and 108 that contain pixels representing various attributes, the ring-based graphical visualization 100 can also include the correlation ring 110. In some examples, such as in FIG. 1, the correlation ring 110 is provided as an outermost ring around the discrete rings that contain pixels representing attributes. In other examples, instead of providing the correlation ring 110 as an outermost correlation ring, the correlation ring 110 can be provided as an innermost correlation ring (inside of the discrete rings containing pixels representing attributes), or alternatively, the correlation ring 110 can be provided between two of the discrete rings containing pixels representing attributes.

The correlation ring 110 has visual indicators for indicating degrees of correlation between at least two of the attributes represented by the pixels in the discrete rings 102, 104, 106, and 108. In some implementations, the visual indicators of the correlation ring 110 include different brightness for indicating different degrees of correlation between the at least two attributes. More generally, the correlation ring 110 has visual indicators for indicating degrees of correlation among (two or more) of the attributes represented in the discrete rings containing pixels representing attributes.

The brightness of the correlation ring 110 at any given annular position in the correlation ring 110 represents the degree of correlation among the attributes at the corresponding time interval. In FIG. 1, it is assumed that the correlation ring 110 provides an indication of correlation among the four attributes Amb, cpu1Temperature, cpu2Temperature, and Util. Such a correlation ring provides for a global view of correlations among multiple attributes (in multiple discrete rings). In other examples, the correlation ring 110 can indicate correlation among less than all of the attributes Amb, cpu1Temperature, cpu2Temperature, and Util.

In some implementations, a user can select any two or more of the attributes of the discrete rings for correlation. For example, the user can select just two attributes, select three attributes, and so forth. The selection can be accomplished using any of various techniques, such as drawing a selection box, entering the attributes into a control menu, clicking on the discrete rings, and so forth.

As an example, the brightness of the correlation ring 110 at the annular position corresponding to the radial axis 112 represents the degree of correlation among the attributes Amb, cpu1Temperature, cpu2Temperature, and Util at the time interval (e.g. 19:51) corresponding to the radial axis 112. A higher brightness indicates that there is a higher degree of correlation, while a lower brightness, such as at the annular position corresponding to radial axis 116, indicates a lower degree of correlation.

Where there is no correlation among attributes, the corresponding portions of the correlation ring 110 can be faded. Fading a portion of the correlation ring can refer to making the portion darker as compared to other portions of the correlation ring 110 that indicate various degrees of correlation among the attributes. In some examples, the faded portion of the correlation ring 110 can be made black, such as in portion 118. Fading non-correlated areas allows an analyst to better focus on areas of higher correlation.

In the example of FIG. 1, two regions of relatively high correlation are indicated: a first region 122 and a second region 124. The region 122 indicates a relatively high degree of correlation due to relatively high correlation among the attributes Amb, cpu1Temperature, and cpu2Temperature. Such correlation may indicate that high ambient temperature is causing high CPU temperatures. The brightness (or other visual indicator) at a respective portion of the correlation ring 110 can be based on an aggregate of pair-wise correlations between the pairs of the four attributes, as discussed further below.

In the region 122, there is a relatively high degree of correlation between the ambient temperature (Amb) and the temperatures of the first and second CPUs—this may indicate that high ambient temperature is causing high CPU temperatures. Note that there is low correlation between system utilization (Util) represented by the discrete ring 108 and the CPU temperature attributes represented by discrete rings 104 and 106 in region 122.

In region 124, there is relatively high correlation between system utilization (Util) and the temperatures of the CPUs—this may indicate that high system utilization is leading to increased CPU temperatures. Note, however, that in region 124, there is relatively low correlation between the ambient temperature represented by the discrete ring 102 and the CPU temperatures represented by the discrete rings 104 and 106.

FIG. 1 also shows that the rings, 102, 104, 106, 108, and 110 are separated from each other by visible boundaries, in the form of dark circles between the rings. This allows a user to easily recognize groups of pixels for corresponding different attributes and the correlation ring.

Although just one correlation ring 110 is shown in FIG. 1, it is noted that in other examples, a ring-based graphical visualization can include multiple correlation rings. Each of the multiple correlation rings can represent correlation among attributes of a corresponding different subset of the attributes represented by the discrete rings 102, 104, 106, and 108.

A user can select a particular pixel in any of the discrete rings 102, 104, 106, and 108 to obtain additional information regarding the pixel (a “drill-down” operation). For example, when a user moves a cursor over a particular pixel, a pop-up box can be displayed to depict additional information regarding the selected pixel. Additionally, a user can zoom into a particular portion of the ring-based graphical visualization 100 to obtain a larger view of the portion. A user can also perform other interactive tasks with respect to the multi-attribute ring-based graphical visualization 100 to perform other tasks.

By using the correlation ring, such as the correlation ring 110 of FIG. 1, a user can find correlations among attributes more easily. In this way, the correlations can be used by the user to identify root causes and chains of causation among the attributes. The visual indicators or the correlation ring (e.g. 110) allow for correlation strength to be highlighted, such that the user can focus on more interesting time intervals (which correspond to higher degrees of correlation). Regions of higher degrees of correlation can correspond to abnormal or unwanted behavior, such as peaks in a particular attribute.

As noted above, a degree of correlation represented by a visual indicator (e.g. brightness) in the correlation ring 110 can be based on pair-wise correlations between attributes represented by the discrete rings 102, 104, 106, and 108 containing pixels representing corresponding attributes. A pair-wise correlation refers to a correlation between a pair of attributes. In the example of FIG. 1, there are four attributes, and thus there can be six pairs of attributes: {Util, cpu1Temperature}, {Util, cpu2Temperature}, {Util, Amb}, {cpu1Temperature, cpu2Temperature}, {cpu1Temperature, Amb}, and {cpu2Temperature, Amb}. A pair-wise correlation is computed for each of the foregoing pairs.

In some examples, to compute a correlation between a pair of attributes, a sliding time window can be moved over the two attributes of each pair, and a Pearson correlation coefficient (or other type correlation coefficient) can be calculated for the pair in the corresponding time window. The correlation coefficient computed for a particular time window between a pair of attributes (A1, A2) can be computed as follows:

$$C ( A 1 , A 2 ) = \{ \begin{matrix}1 , if Δ A 1 , Δ A 2 \approx 0 \\ else \vert \frac{Cov ( A 1 , A 2 )}{\sqrt{Var ( A 1 )} * \sqrt{Var ( A 2 )}} \vert\end{matrix} \}$$

C:=Correlation of A1 and A2
A1, A2:=Attributes
ΔA:=Gradient of Attribute
Cov:=Covariance
Var:=Variance

In the foregoing, the correlation coefficient C between attributes A1 and A2 is set to the value 1 if there is no (or low) change in values of attributes A1 and A2 in the particular time window (ΔA1, ΔA2≈0). In other words, if the values of both attributes A1 and A2 do not change over the time window, or the difference between the attributes A1 and A2 is less than some predefined threshold, the correlation coefficient C is set to the value 1 (or 0 or some other predefined value according to user specification). On the other hand, if there is change in value of either or both of attributes A1 and A2 that is greater than the predefined threshold, then the correlation coefficient C is computed according to dividing the covariance of A1 and A2 by the product of the square root of each of the variants of A1 and A2, as specified in the equation above.

A higher value of the correlation coefficient C indicates a higher degree of correlation. In other examples, other types of correlation coefficients among two or more attributes can be computed.

In examples where correlation coefficients (e.g. C1, C2, . . . , Cn, where n>1) are computed for multiple respective pairs of attributes, then an aggregate (e.g. average, median, etc.) of the pair-wise correlation coefficients C1, C2, . . . , Cn can be computed to determine the overall degree of correlation among the attributes. The respective visual indicator in the correlation ring can be set according to this overall degree of correlation.

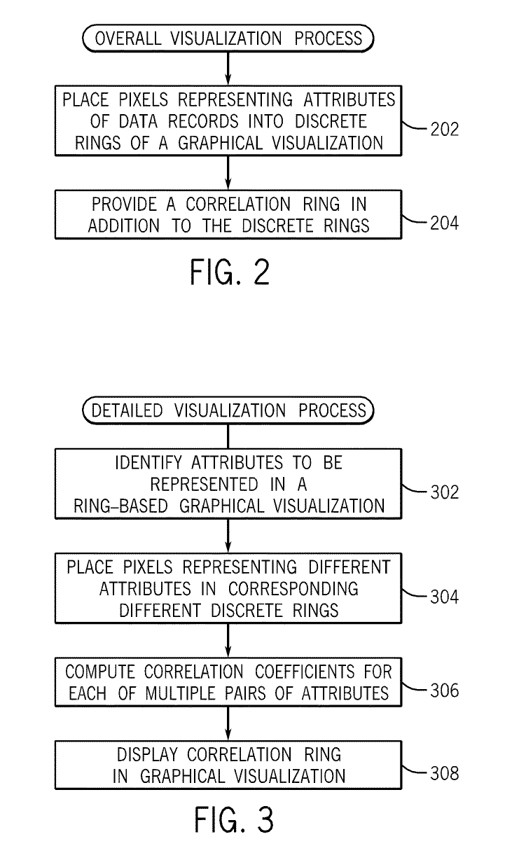

FIG. 2 is a flow diagram of a visualization process according to some implementations. The process places (at 202) pixels representing attributes of data records into discrete rings of a graphical visualization, such as the graphical visualization 100 of FIG. 1. The discrete rings correspond to respective different ones of the attributes.

The process further provides (at 204) a correlation ring (e.g. 110 in FIG. 1) in addition to the discrete rings, where the correlation ring has visual indicators (e.g. brightness) for indicating degrees of correlation between at least two of the attributes represented in the discrete rings.

FIG. 3 is a flow diagram of a visualization process according to further implementations. The process identifies (at 302) attributes to be represented in a ring-based graphical visualization. Multiple time series of attribute values are received for these attributes.

The process places (at 304) pixels representing the different attributes in corresponding different discrete rings of a graphical visualization. Effectively, each discrete ring contains pixels representing a corresponding time series of attribute values (of a respective attribute).

The process also computes (at 306) correlation coefficients for each of multiple pairs of attributes. Assuming that the correlation is to be performed for more than two attributes, the multiple pairwise correlation coefficients can be aggregated to produce an overall correlation coefficient, which can be used to determine the corresponding visual indicator to be used in a correlation ring.

The process then displays (at 308) the correlation ring in the graphical visualization, where the correlation ring has visual indicators for indicating degrees of correlation among the attributes according to the calculated correlation coefficients.

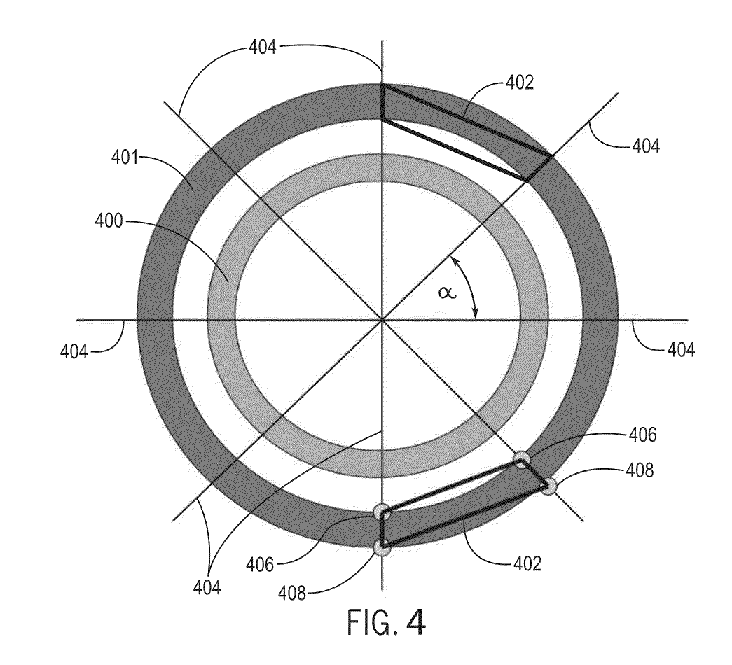

FIG. 4 shows two example discrete rings 400 and 401 along with various parameters associated with each discrete ring. The discrete rings 400 and 401 can correspond to any two of the discrete rings 102, 104, 106, and 108 in FIG. 1.

A number of sectors is calculated for each discrete ring. Note that both discrete rings 400 and 401 include the same number of sectors. Each sector is represented generally by a polygon 402 in FIG. 4. Each polygon 402 defines generally the area in which a corresponding pixel in the discrete ring 401 is located. The number of sectors 402 depends upon the number of pixels to be included in the discrete ring. Based on the number of sectors 402 to be included in the discrete ring, a sector angle (represented as ∝) can be determined. The sector angle is the same for each of the sectors of the discrete ring.

Sector lines 404 define a sector 402. Each sector 402 is defined between two adjacent sector lines 404. Two radial points 406 and 408 along each sector line 404 can be determined for each corresponding discrete ring. The two radial points 406 and 408 define the width of a discrete ring, which in the example in FIG. 4 is discrete ring 401. The points 406, 408 on the sector lines 404 are connected together to form a polygon 402.

In FIG. 4, each discrete ring 400 or 401 includes eight pixels (which correspond to the eight sectors defined by the sector lines 404 of FIG. 4). In total, the two discrete rings 400 and 401 include 16 pixels.

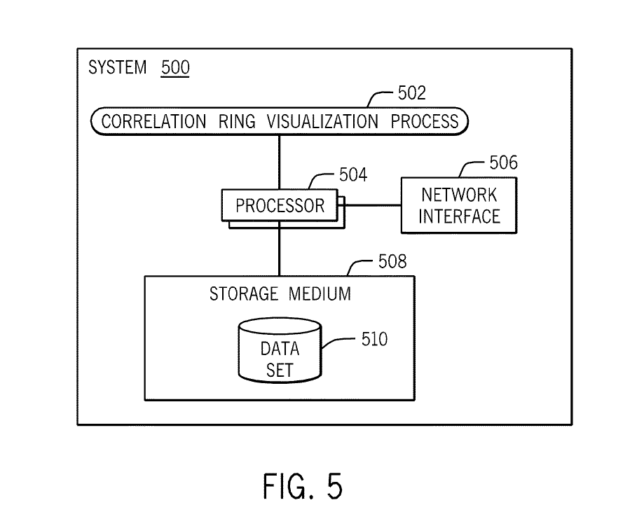

FIG. 5 is a block diagram of an example system 500 that includes a correlation ring visualization module 502 executable on one or more processors 504. A processor can include a microprocessor, microcontroller, processor module or subsystem, programmable integrated circuit, programmable gate array, or another control or computing device.

The correlation ring visualization module 502 is able to perform processes discussed above, including processes of FIGS. 3 and 4, for example. The processor(s) 504 can be connected to a network interface 506 to communicate over a network and can be connected to a storage medium (or storage media) 508. The storage medium (or storage media) 508 can store a data set 510, such as a data set of data records. Data set 510 can be a historical dataset that was previously acquired, or alternatively, the data set 510 can include data points that are continually received by the system 500, where such continually-received data points are visualized in real-time using the correlation ring visualization module 502.

The storage medium (or storage media 508) can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
placing, by a system having a processor, pixels representing attributes of data records into discrete rings of a graphical visualization, where the discrete rings correspond to respective ones of the attributes, and where the pixels are arranged in each of the discrete rings according to time intervals of the data records; and
providing a correlation ring in the graphical visualization in addition to the discrete rings, where the correlation ring has visual indicators for indicating degrees of correlation between at least two of the attributes.

2. The method of claim 1, wherein each of the discrete rings contains pixels representing a corresponding time series of attribute values for a respective one of the attributes.

3. The method of claim 1, wherein the visual indicators comprise different brightness for indicating corresponding degrees of correlation.

4. The method of claim 1, wherein the correlation ring is provided as an outermost ring around the discrete rings.

5. The method of claim 1, further comprising, in a particular one of the discrete rings, assigning colors to the pixels according to values of the attribute corresponding to the particular discrete ring.

6. The method of claim 1, further comprising fading portions of the correlation ring corresponding to time intervals of low correlation between the at least two attributes.

7. The method of claim 1, further comprising:
receiving a selection of one of the pixels; and
displaying information of the data record represented by the selected pixel.

8. The method of claim 1, wherein the correlation ring has visual indicators for indicating degrees of correlation between more than two attributes, the method further comprising:
computing pair-wise correlation coefficients for corresponding pairs of the more than two attributes, in successive time windows; and
aggregating the pair-wise correlation coefficients in each of the time windows to indicate a corresponding degree of correlation among the more than two attributes.

9. An article comprising at least one machine-readable storage medium storing instructions that upon execution cause a system to:
determine degrees of correlation among a plurality of attributes of data records;
generate a ring-based graphical visualization having a plurality of discrete rings for respective ones of the plurality of attributes;
place pixels representing the attributes of the data records into the discrete rings, where the pixels placed into a particular one of the discrete rings correspond to a respective one of the attributes, and where the pixels are arranged in each of the discrete rings according to time intervals; and
provide a correlation ring in the ring-based graphical visualization in addition to the discrete rings, where the correlation ring has visual indicators for indicating the degrees of correlation among the plurality of attributes.

10. The article of claim 9, wherein the instructions upon execution cause the system to further:
receive user selection of a particular one of the pixels; and
display information of a data record corresponding to the particular pixel in response to the received user selection.

11. The article of claim 9, wherein each of the discrete rings contains pixels for a corresponding time series of attribute values.

12. The article of claim 9, wherein the instructions upon execution cause the system to further:
assign different colors to the pixels according to corresponding attribute values.

13. The article of claim 9, wherein determining the degrees of correlation comprises determining pairwise correlation coefficients between respective pairs of the plurality of attributes, and wherein the instructions upon execution cause the system to further
compute an aggregate correlation coefficient based on aggregating the pairwise correlation coefficients; and
generate the visual indicators for the correlation ring based on the aggregate correlation coefficient.

14. The article of claim 9, wherein the visual indicators are provided for respective time intervals according to the degrees of correlation among the plurality of attributes in the corresponding time intervals.

15. The article of claim 9, wherein the visual indicators comprise different brightness, where greater brightness indicates a higher degree of correlation among the plurality of attributes.

16. A system comprising:
at least one processor to:
place pixels representing attributes of data records into discrete rings of a graphical visualization, where the discrete rings correspond to respective ones of the attributes, and where the pixels are arranged in each of the discrete rings according to time intervals of the data records; and
provide a correlation ring in the graphical visualization in addition to the discrete rings, where the correlation ring has visual indicators for indicating degrees of correlation between at least two of the attributes.

17. The system of claim 16, wherein the visual indicators comprise different brightness, where greater brightness indicates a higher degree of correlation among the plurality of attributes.
